(19) United States
(12) Patent Application Publication
(10) Pub. No.: US 2010/0160022 A1
(43) Pub. Date: Jun. 24, 2010

(54) FLEXIBLE SELF-DESCRIBING WAGERING GAME ENTRIES

(75) Inventor: Thomas K. ORAM, Hudson, MA (US)

Correspondence Address: SULLIVAN & WORCESTER LLP, 1666 K Street NW, Washington, DC, 20006, US

(73) Assignee: GTECH CORPORATION, Providence, RI (US)

(21) Appl. No.: 12/344,020

(22) Filed: Dec. 24, 2008

(51) Int. Cl. A63F 9/24; G06F 19/00; G09B 19/22

(52) U.S. Cl. 463/17; 463/43; 283/48.1

(57) ABSTRACT

Systems and methods are described for various lottery, gaming and other applications. The systems and methods may be configured to extract player selection data from a digital image of a selection slip or other document. The extraction of player selection data may be based on information read from the slip indicating how player-written marks found on the slip should be interpreted.

### BACKGROUND

Wagering games are common throughout the world, e.g., regulated state or governmental lotteries. Many of these games, e.g., future draw games like Lotto, Powerball, and Keno allow players to enter a game by submitting a play slip on which the player indicates one or more selections which correspond to a game entry option. For instance, a typical lottery game may allow the user to hand-write, bubble-in, punch-out or otherwise mark a series of their “lucky” numbers to indicate a selection that will later be compared to a series of randomly drawn winning numbers. Alternatively, the player may mark areas to indicate they want a “quick pick” selection that is randomly chosen by the game provider. Information indicated on the play slip by the player may also include an identification of the drawing or game entered, the number of entries or chances desired, the amount wagered per entry, the type of bet, e.g., selected from a variety of possible rules for determining a game result, sometimes each having different respective payouts, as well as other information. Similar types of play slips may be used to allow entry into other types of games, such as pari-mutual horse race wagering, other types of sports betting, raffles and promotional drawings, etc.

To increase player participation, promote sales, and increase revenues, game operators are constantly introducing new games and new “play styles”. One reason for the success of pre-printed instant “scratch-off” tickets is believed to be the ease with which a wide range of different games that provide variety and appeal to different players can be presented. In contrast, introducing a new game that requires different forms or arrangements of player input may require substantial reprogramming of agent-operated lottery terminals, self-serve lottery terminals, and lottery ticket vending machines or kiosks. This greatly increases the time and cost needed to introduce new games that require different forms of player input, particularly in comparison with “scratch-off” games, where new games can merely be printed with a completely different appearance and little or no change to the lottery ticket processing infrastructure.

Moreover, each game operator, e.g., the various state lottery authorities, may have slightly different requirements, requiring different arrangements of play slip inputs, different notices, and different combinations of other features. Even if a single vendor supplies systems to multiple lotteries, the need to customize features for each jurisdiction increases the costs and time required to introduce new lottery games that require player input. Similarly, sport betting operations or other wagering systems may constantly be changing the possible wagers available to players, e.g., with both the changing schedule of sporting events (e.g., special bets on the Olympics) and with new types of bets. Changing entry mechanisms may be time-consuming and expensive to provide in conventional entry devices.

When the play slip is read by a conventional processing device (e.g., a game terminal) the processing device obtains information indicating the player's game play selections, generally using an input routine that is custom programmed by a programmer with knowledge of the play slip format. Because the selections are always made at the same location(s) on the play slip, the processing device must know the location(s) in order to read the slip. The proper location is generally identified by programming the terminal to read and process the play slip at a particular standard location, and training or instructing the terminal operator to put the slip into or against a reading device with the correct orientation. For instance, sensors may be disposed at predetermined locations which correspond to the locations of the selections. While a conventional linear bar code scanner will read a bar code from essentially any location on a ticket or card, processing player written inputs, e.g., those made by marking or writing with a writing instrument, generally requires that the terminal be programmed to look for appropriate markings in the correct location. Marks made in incorrect locations may hinder or cause problems with the reading process. One need only recall the care required in filling out the forms for “mark-sense” forms used for standardized testing.

Current lottery systems sometimes allow the locations of player inputs on a play slip to be varied depending on the particular game being played. Each game may have a different selection requirement such as a total number of selections, a physical arrangement of the selections, valid combinations of different selections, etc. Accordingly, different configurations of play slips may be provided. Lottery terminals are generally pre-programmed with lookup data structure, such as a table or program instructions to determine, based on a slip type, how to read the slips. The most common approach is to encode in a barcode the type of slip being read. The lottery terminals may also be pre-programmed with instructions on how to process data contained on the slips. When a new game is introduced, new software instructions and/or new tables must be loaded into every lottery terminal in the system. The process of loading software or tables to a lottery terminal can be complex and often causes delays and increased cost in the introduction of new games.

### BRIEF DESCRIPTION OF THE DRAWINGS

FIG. 1 illustrates an example gaming system, according to an example embodiment of the present invention.

FIG. 2 illustrates another example gaming system, according to an example embodiment of the present invention.

FIG. 3 illustrates an example play slip, according to an example embodiment of the present invention.

FIG. 4 illustrates another example play slip, according to an example embodiment of the present invention.

FIG. 5 illustrates another example play slip, according to an example embodiment of the present invention.

FIG. 6 illustrates another example play slip, according to an example embodiment of the present invention.

FIG. 7 illustrates an example game receipt, according to an example embodiment of the present invention.

FIG. 8 illustrates an example agent-operated game terminal, according to an example embodiment of the present invention.

FIG. 9 illustrates an example player-operated game kiosk, according to an example embodiment of the present invention.

FIG. 10 illustrates an example procedure for processing a play slip, according to an example embodiment of the present invention.

FIG. 11 illustrates another example procedure for processing a play slip, according to an example embodiment of the present invention.

FIG. 12 illustrates an example procedure for processing a game receipt, according to an example embodiment of the present invention.

### DETAILED DESCRIPTION OF EXAMPLE EMBODIMENTS

Some example embodiments of the present invention address a growing need for lottery systems with the capability of processing a wide variety of different types of game play slips while at the same time avoiding the need to reprogram or reconfigure every terminal in the system when a new game is introduced. These example embodiments include systems and methods for providing processing of play slips of new types and styles, without the need to reprogram the devices, e.g., lottery terminals, kiosks, or other types of client devices that read and process the play slips. Instructions and/or data may be included as encoded data contained in the play slip. This enables the exemplary systems to process the play slip without requiring terminal re-programming for each new play slip or game type that is introduced. Other example embodiments of the present invention include play slips that include encoded data. These play slips may be self-describing and may include encoded data relating to features of the play slip and instructions and/or data configured to allow the features of the play slip to be interpreted by a device reading the play slip.

Some other example embodiments include systems and methods for processing other types of human written input media with self-describing features similar to those described above for wagering play slips, as well as the example self-describing input media configured to be used with such systems. Although example embodiments will be described with reference to play slips, the present invention may be implemented with any manual input data entry form. In other embodiments, such forms may include standardized testing forms where answers are marked (e.g., Scantron forms), markable coupons (e.g., making a choice between receiving a $2 discount or a free item), sports betting entry slips, restaurant or merchandise order slips, etc.

The following descriptions of the example embodiments of the present invention reference the terms “communications” and “in communication with”. As used throughout the present application, these terms refer to device or system components which are in electrical or optical communication with each other. This may include both digital and analog communication, both synchronous and asynchronous communication, and may be wired as well as wireless communication, using both direct (e.g., device-to-device) and indirect (e.g., networked through an intermediate device) communication.

One example embodiment of the present invention includes a system for processing a selection slip for a game. The system may include a gaming terminal, such as dedicated agent-operated lottery terminal, unattended kiosk or vending machine, personal computer, mobile device, or other form of client device. The gaming terminal may include an imaging device configured to generate a digital image of a player selection slip. The gaming terminal may also include a slip processing engine configured to extract player selection data from the digital image of the selection slip, the extraction of player selection data based on information read from the slip indicating how player-written marks found on the slip should be interpreted, and a communication engine configured to communicate requests for game execution to a game services engine, the requests based at least in part on player selection data extracted by the slip processing engine. The gaming terminal may also include a receipt generator configured to generate a game receipt based at least in part on the player selection data. The example system may also include a game services engine, e.g., at a lottery host, that is configured to execute instances of the game. The game services engine may include a game entry engine configured to receive and process information indicating player game entries. The game services engine may also include an outcome engine configured to determine an outcome of a game, and a validation engine configured to validate redemption requests for the game receipt based at least in part on the player game entries and outcome of the game associated with the game receipt.

Optionally, in the example system, information indicating how player-written marks should be interpreted includes location information indicative of the location of a selection area on the form relative to the remainder of the form.

Another example embodiment of the present invention is a system for processing a manual input entry form. The system may include an imaging device, e.g., a CCD camera, configured to generate a digital image of the form. The system may also include a reading device configured to read encoded data from the form, the encoded data including location information indicative of the location of a selection area on the form relative to a remainder of the form.

Optionally, the encoded data may include instructions indicating how selection marks contained within the selection area should be interpreted. The encoded data may be contained in at least one of a bar code, an RFID tag, a printed character sequence, an integrated circuit, or a magnetic strip. The example system may further include a slip processing engine configured to extract the selection area from the digital image of the form using the location information. The system may also include a selection area analysis engine configured to interpret selection marks written by a user in the selection area. The system may also include game play engine, e.g., at a central host, that may be configured to enter the user in a wagering game, the user's entry in the wagering game based at least in part on the interpretation of the selection marks made by the selection area analysis engine. Optionally, the imaging device and the reading device, which may be separate or integrated, may be part of a self-service lottery terminal, an agent-operated lottery terminal, a personal computer, a mobile device, or a conventional point-of-sale terminal such a grocery store checkout terminal.

Optionally, the system may include an entry form generation device configured to generate the form. The reading device is configured to receive the digital image from the imaging device and to extract the encoded data from the digital image.

Another example embodiment of the present invention is a system for providing services to lottery operators. The system may include a shared lottery host accessible to a plurality of game terminals. The system may also include a game archive accessible to the shared lottery host storing software code configured to operate a plurality of wagering games at the game terminals, the games are selectively activatable by the operator of the plurality of game terminals, at least one of the games configured to receive play selections for game play using player selection slips that include stored play slip decoding information. The shared lottery host may be configured to download, responsive to a request to activate the at least one of the games by the operator of the plurality of game terminals, software configured to at least one of generate or decode the player selection slips for the game. The terminal may be, e.g., a conventional retail point of sale terminal configured to provide gaming services, a dedicated agent-operated lottery terminal, a player-operated lottery vending machine or kiosk, a mobile device, or personal computer.

Optionally, the downloaded software includes a program configured to generate player selection slips that include the instructions indicating how the player selections slips should be interpreted.

In another optional alternative, the software may be a decoding program, and the plurality of game terminals may be configured to execute the decoding program to interpret the player selection slips for the game. The decoding may be based at least in part on instructions provided on the player selection slip that indicate the location of a selection area on the player selection slip relative to a remainder of a player selection slip. The decoding program may include instructions on how to determine whether player selections located in the selection area are valid. Alternatively, the decoding program may include instructions to locate the selection area based on one of coordinate information, delimiting marks, edge detection and background image. Optionally, at least one of the terminals may include a digital imager configured to capture an image of the slip and perform an image extraction procedure to locate the selection area in accordance with the instructions of the at least one decoding program.

In another optional alternative, stored play slip decoding information may be contained in one of a bar code, an RFID tag, a printed character sequence, an integrated circuit or a magnetic strip on the play slip. At least one of the terminals may be configured to produce a receipt including human readable versions of the player selections and transmit the player selections for storage at the shared host. The terminal may be configured to apply the player selections toward a new instance of a game after receiving the receipt from a player.

Depending on the implementation, at least one of the terminals may be configured to generate the slips, the slips may be generated by the shared lottery host, or they may be pre-printed and manually distributed.

Another example embodiment of the present invention is a method for processing a manual input entry form. The method may include reading encoded machine-readable data from the form with an input device at a terminal; decoding the encoded data to obtain location information indicative of the location of a user selection area on the form relative to a remainder of the form; and using the location information to determine with the terminal the user selections contained within the indicated selection area. Optionally, the user selections may be indicated by writings made by the user in the selection area with a writing instrument. The example method may further include generating a receipt containing human readable versions of the user selections. The example method may include storing the user selections in at least one of a remote database and an encoded data portion of the receipt.

In one alternative, the example method may also include after receiving the receipt at a terminal, generating a new instance of an operation initiated by the decoding of the entry form using the user selections contained on the receipt. Optionally, the new instance may be performed only after confirming the user's consent to the new instance by reading a consent indicating area of the receipt. The consent indicating area may be located by extracting location information from data encoded on the receipt.

In another alternative, the example method may also include reading the receipt to obtain encoded data corresponding to a second entry form; generating the second form; and applying user selections located on the second form towards another instance of an operation initiated by the decoding of the first form.

In the above example methods, the form may be, for example, a wagering slip for a lottery game, or a wagering slip for a sports betting game. The encoded data may further indicate at least one of patterns or colors on the form that should be ignored when reading the user selections. The location information may be indicated with reference to a known reference point on the form. Alternatively, the encoded information may provide an indication of reference symbols on the form which can be located and which, once located provide the known reference point on the form. The above example methods may also include capturing a digital image of the form, wherein the reading of the form is performed using the digital image. The capturing of the digital image may be performed by a terminal including a digital imager, e.g., a retail point-of-sale terminal.

Another example embodiment of the present invention may be an article of manufacture, comprising a computer readable medium having a computer-readable program code embodied therein, the computer readable program code may be configured to be executed to carry out any of the above-described example method embodiments.

Another example embodiment of the present invention is a manual input entry form. The form may include a selection area configured to allow a user to mark a selection; and a machine-readable encoded data, the data including location information indicative of a location of the selection area relative to a remainder of the form. The selection area may be configured to allow the user to mark the selection by writing in the selection area with a writing instrument. The encoded data may be located on one of a bar code, an RFID tag, a printed character sequence, an integrated circuit, or a magnetic strip. The location information may include coordinate information. Alternatively, the instructions may be configured to locate a distinguishing feature of the selection area, e.g., a delimiting mark, an edge of the selection area, or a background image of the selection area. The encoded data may also include instructions configured to control interpretation of the selection, information configured to be used to determine whether the selection is a valid selection, or information identifying a service provider capable of processing the form. The encoded data may include at least one of a game identifier, a game logo, a reference to a game identifier, and a reference to a game logo.

The above example entry forms may be, e.g., a wagering slip for a lottery game, or a wagering slip for a sports betting game.

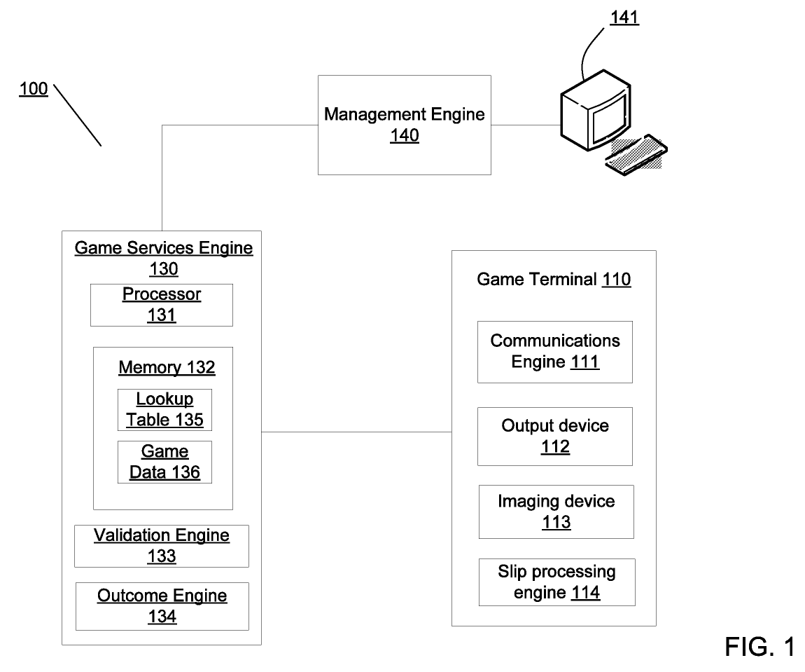

FIG. 1 illustrates an example gaming system, according to an example embodiment of the present invention. As illustrated in FIG. 1, the example system 100 may include a game terminal 110 in communication with a game services engine 130. The game services engine 130 may be in communication with a management engine 140 operated by a user of a management device 141, e.g., an employee or manager of the game operator, such as a state lottery authority or private gaming company. The terminal 110 may be configured to provide access to a lottery game run by a lottery operator such as a state lottery authority or a private casino. Accordingly, the terminal 110 may be located at a variety of player accessible locations including retail stores, gas stations, off-track betting parlors, casinos, shopping malls, bars, restaurants, etc. Example terminals may include agent-operated lottery terminals, conventional retail point-of-sale terminals with added lottery capability, self-service kiosks, mobile devices, personal computers, video game terminals, and other devices. The terminal 110 may include integral devices for reading and processing a play slip. In one example embodiment, the terminal 110 may include an arrangement for automatically accepting and processing the play slip, e.g., a slot acceptor into which the play slip is inserted and an integral digital imager configured to capture an image of the inserted slip. However, in other embodiments, one or more of the functions of the terminal 110 may be performed with the assistance of a human operator, e.g., a store clerk operating a digital imager. Examples of a digital imager which may be utilized in conjunction with the example terminal 110 are described in U.S. Published Patent Application No. 2006/0217821, SYSTEM AND METHOD FOR PROCESSING A FORM, to Abraitis et al., which describes an area-array image sensor configured to sense an image of a form, e.g., a lottery ticket in free-space. The area-array image sensor may enable markings found in an image of the form to be sensed without the use of a stand for positioning the form in a predetermined position with respect to the sensor.

An alternative example embodiment may utilize a modified version of a conventional unattended lottery ticket kiosk, such as the Lottery To Go™ and Lotto to Go™ terminals from GTECH Corporation of Providence, R.I. These two terminals are self-service terminals which enable players to purchase and check tickets without the assistance of a lottery agent. These unattended terminals may be modified to include a digital camera to read a player-presented play-slip or ticket, e.g., a play slip reader such as the digital imager described by Abraitis et al. An example is imager used in the Imagine™ Terminal, which is also available from GTECH Corporation, and which employs a digital camera to read play slips. The camera may be physically integrated in the terminal or may be provided in peripheral communication with the terminal. The camera may be placed in any convenient, user accessible location such as in front of the vending machine or in a cavity which is positioned to make clear where the player should place the ticket for scanning. The camera may be oriented such that an image sensor faces the play slip when the slip is placed in a scanning position. For example, if the slip is placed in a cavity, the image sensor may be facing downwards. Another example is placing the image sensor in a forward facing direction. In some embodiments, the orientation of the camera may be adjustable, either manually or through electronic controls such as a control panel coupled to a servo motor.

Another alternative example embodiment may utilize modified conventional, non-lottery terminals, e.g., point-of-sale (POS) terminals, in conjunction with a digital imager. A POS terminal may be located at virtually any location including places not normally associated with wagering such as supermarkets and shopping centers. Wagers, once imaged, may be received by a regional server belonging, for example, to the store chain headquarters or a financial transaction processing server. The regional server may decode a digital image of a play slip in the manner of the slip processing engine 114 described below before forwarding the wager to a gaming service such as the game services engine 130. Alternatively, the decoding of the digital image may be performed at the gaming service by, for example, transmitting only the digital image from the regional server to the gaming service.

As shown in FIG. 1, the terminal may include a communications engine 111, an output device 112, an imaging device 113 and a slip processing engine 114. The communications engine 111 enables the terminal 110 to communicate with the game services engine 130 and may include any number of conventional communications arrangements, such as a direct cable connection, a wireless connection and intermediary communications networks, e.g., a LAN, a WAN, a secure Internet connection, etc. The output device 112 may include a display on which game information is displayed to a player. The display may be touch-sensitive and may define a user interface through which the player may select from amongst various game options. For example, the player may use the display to select a game to play and a method of payment. The imaging device 113 may include one or more components configured to capture and process player selections. In one example embodiment, the imaging device 113 may include a digital imager configured to capture a digital image of the entire play slip. The imaging device 113 may also be configured to read encoded data located on the play slip. As will be discussed in detail below, the encoded data may provide location information indicative of a location of a selection area of the play slip containing the player selections. The encoded data may be contained in any number of portable formats including, but not limited to, bar codes, RFID tags, printed character sequences, integrated circuits (e.g., storage on smart cards) and magnetic strips. Accordingly, the imaging device 113 may include a component corresponding to the format of the encoded data (e.g., a bar code scanner, an RFID reader, a mag-stripe card reader, a smart card reader, etc.). Alternatively, in other embodiments, non-optical encoded data may be read using a separate reading device of the terminal.

The slip processing engine 114 may be implemented in any combination of hardware and/or software. In one example embodiment, the slip processing engine 114 may include a processor executing instructions for decoding the play slip. The instructions may include a pre-programmed routine including, e.g., capturing a digital image of the play slip, reading the encoded data from the play slip, extracting the location information from the encoded data, locating the selection area on the play slip based on the location information, and executing a game based on the player selections which have been indicated by marking in the selection area. It will be appreciated that the processor may be configured, e.g., under software control, to perform the various example procedures described elsewhere in the present application. It will be appreciated that the slip processing engine may be provided in a game terminal, so that slips are processed before information from the terminal is communicated to the rest of the system. Alternatively, raw or partially processed digital images may be forwarded from the terminal and processed centrally. The central processing approach greatly increases the amount of network bandwidth required, but may reduce the amount of functionality and processing required at the terminal, potentially allowing a much thinner client. The central processing approach also decreases the need to distribute upgrades and changes to the distributed terminals.

The game services engine 130 may perform game execution based on a request from the slip processing engine. In the example embodiment illustrated in FIG. 1, the services engine 130 is separate from the terminal 110. For example, the services engine 130 may be located on a host device such as a remote server controlled by the lottery operator. However, it will be appreciated that game execution may also be provided at the terminal 110 or a subset of the functions of the services engine 130 may be performed locally in other alternative embodiments. The services engine 130 may include a processor 131, a memory 132, a validation engine 133 and an outcome engine 134. The processor 131 may be any type of general-purpose processor and/or may be an application specific processor or the like. The processor 131 may provide a virtual machine environment which enables platform-independent execution of game instructions by converting instructions or code into machine language and executing them.

The memory 132 may be a system memory and/or a storage memory. The memory 132 may be any type of memory including solid-state memories, optical drives, electromagnetic storage media such as magnetic disks, conventional RAM, flash memory, etc. The memory 132 may include a lookup table 135 (e.g., a lookup data structure or reference index, although it will be appreciated that no particular data structure is required) and game data 136. The lookup table 135 may include a database of references (e.g., pointers, although it will be appreciated that other mechanisms for associating information may be used) to content associated with each game. For example, each game may be executed by locating the table entry corresponding to the game and executing an instruction referenced by the table entry. The game data 136 may include the game instructions and other content such as game parameters, library code and other game resources.

The validation engine 133 may be configured to perform validation of game receipts. The validation may be performed by a program, subprogram or subroutine, process, agent, or task executing on a central processor of the host device. Alternatively, the validation engine may be configured to execute a request from a remote validation service such as a web-based request to a third-party validation organization. Winning receipts presented for redemption by players at the terminal 110 may be subjected to a validation procedure in which the authenticity and/or validity of the receipt is determined. For example, the validation engine 133 may include hardware and/or software configured to verify that the receipt was in fact properly issued by the terminal 110 or another terminal at which the game is available. The validation engine 133 may also compare player selections from the receipt to winning selections stored in a database. Alternatively, a ticket serial number may be looked up in a “winner file” identifying prize winner tickets. In this manner, the lottery operator may restrict the issuance of winnings to holders of valid winning receipts that have not been previously redeemed.

Various approaches to using customer marked data on the receipt in the validation and redemption procedures may be employed. For example, in some alternative embodiments, player marks on the receipt may also be processed by the slip reader and used in the validation process. For example, a player could be asked to sign or initial both the entry form and the ticket presented for redemption, and the digitized signatures from both could be compared in order to insure that the player redeeming the ticket was the player who actually purchased the ticket. For example, the various algorithms described in PROGRESS IN AUTOMATIC SIGNATURE VERIFICATION (SERIES IN MACHINE PERCEPTION AND ARTIFICIAL INTELLIGENCE, VOL. 13), World Scientific Publishing Company, edited by Rejean Plamondon (October 1994), could be employed for signature comparison.

The outcome engine 134 may be configured to determine game results based on the execution of the game instructions. The outcome may be a program, subprogram or subroutine, process, agent, or task executing on a central processor of the host device, or may also be provided as a separate remote program executing on a separate processor from other system components, e.g., provided through a web service accessible to the game operator. The outcome engine 134 may store the results in a database such as the memory 132 or a secure server. The outcome engine 134 may also deliver the results to the terminal 110. Results may be generated pseudo-randomly from a prize pool, by reference to external events such as sport results, or by accessing other sources of unpredictable outcomes that result in a fair and entertaining game experience. Delivery may be performed at regularly scheduled intervals (e.g., after each game is played) or upon request from a terminal operator.

The management engine 140 may be configured to allow lottery operators to connect to the services engine 130 and configure aspects of each game. For example, management engine 140 may execute software enabling the lottery operators to add or remove games from the services engine 130, modify wager limitations or other game rules, view game results, obtain revenue information based on terminal sales, etc. The management engine 140 may communicate with the game services engine 130 through a web service provided by the host device. The management engine 140 may, for example, perform web-based database queries or execute a game configuration program, subprogram or subroutine, process or task executing on the central processor of the host device. The management engine 140 also may provide features for adding new games and new play slip configurations. For example, a new play slip configuration may be specified along with associated bar codes identified by the play slip, and this information may be downloaded to the terminals for processing new play slip configurations. Also, how the customer information read from the play slip is processed may also be specified, e.g., how the player input information specified on the play slip is actually processed by the new game. Although for conventional lottery games, the customer input data extracted from the play slip may be relatively simple, e.g., lottery number selections or number of bets, for other new types of games, for example sports-based wagers, the customer input may be significantly more complicated or have more types of variation. For example, in a spot-the-ball type game, which is popular in the United Kingdom, the entry information might actually be the physical location of the mark in a picture field that represents a predicted position of a missing component in a picture.

Although the example embodiment of FIG. 1 has been described with reference to a terminal which performs the locating of the selection marks, in another example embodiment, a slip processing terminal may only capture a digital image of the slip and transmit the image to a centralized host. The centralized host may then extract and read graphically encoded data from the digital image to extract location information from the image, locate and analyze the selection area, and processes the player selections indicated in the graphical data.

One example of such a terminal is a “thin client” which connects to a centralized server via a web connection. Connecting to the centralized server may be performed using an Internet browser that connects to a web page of the centralized server. The terminal may include a web cam, a flat-bed scanner or any other local imaging device capable of capturing a digital image of sufficient quality (e.g., sufficient image resolution) to enable reading of the encoded data by the centralized host. After the player scans the play slip, the web page may execute a plug-in such as a JAVA applet or a CGI script to transmit the image to the centralized host. The plug-in may encrypt the image to provide for secure transmission. It will be appreciated that this approach may also be used to provide play slip processing at home computers with scanners or digital cameras, or with mobile devices such has camera equipped mobile phones or PDAs.

As illustrated in the example embodiments described above, the encoded data of the play slip enables any slip processing device to locate and interpret the player selections without being pre-programmed to look at a specific location on the slip. This may be accomplished regardless of whether the device with which the player directly interacts performs the locating or whether the locating is performed remotely.

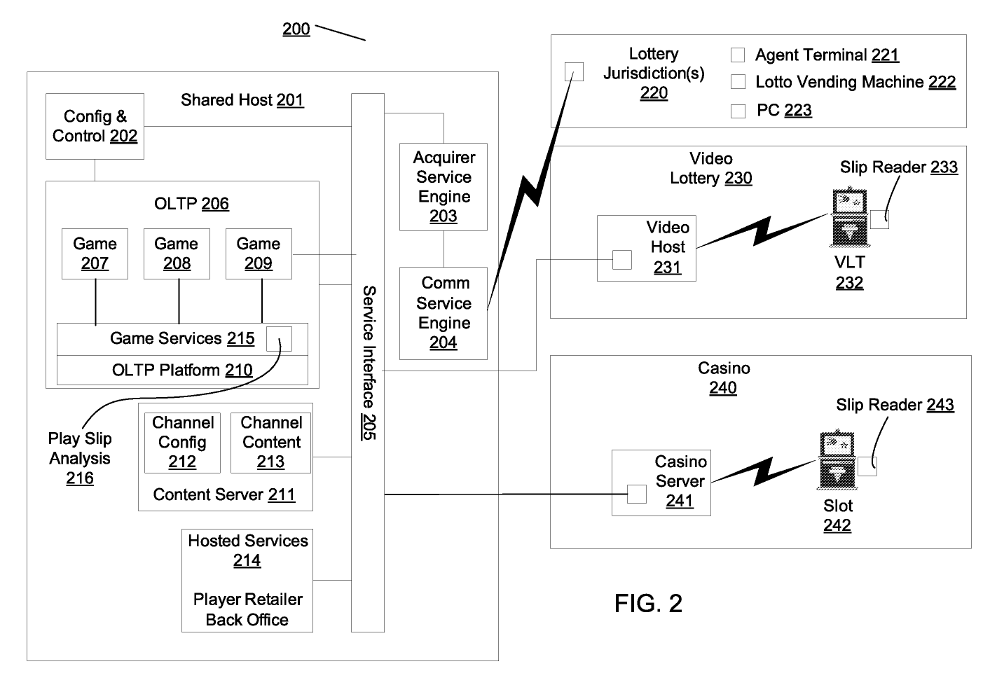

FIG. 2 illustrates an example gaming system 200, according to an example embodiment of the present invention. The system 200 may include a Shared Host 201 that provides a plurality of centralized gaming services to a plurality of lottery operators in different game jurisdictions. These lottery operators may include a Lottery Jurisdiction 220, a Video Lottery 230 operated in social locations such as bars or bowling allies, and a Casino 240. Thus, the system 200 may support regulated state or governmental lotteries, private gaming corporations, both physical and Internet casinos, or other entities that provide legal gaming to customers. It will be appreciated that similar functionality may be provided for a single jurisdiction with its own host or multiple hosts.

The Shared Host 201 may be provided on a single large mainframe computer system or in a distributed fashion with a collection of smaller computer systems, e.g., connected by a high speed local area network. Each of the jurisdictions may access games located in the Shared Host 201. The Shared Host 201 may include components substantially similar to those described in U.S. patent application Ser. No. 12/327,608, filed Dec. 3, 2008 for PROVIDING CENTRALIZED SERVICES TO GAME OPERATORS, to Cautley et al., the contents of which are expressly incorporated by reference in their entirety.

The Shared Host 201 may include a Configuration (Config) & Control System 202. The Config & Control System 202 may handle management and reporting functions, e.g., the distribution of real time, daily, or monthly accounting reports of various types, the control of system configurations, and monitoring and service level agreement metric monitoring and control, e.g., performance management, availability management, etc.

The Shared Host 201 may also include an online transaction processing (OLTP) system 206. The OLTP system 206 may be implemented using conventional OLTP tools such as order processing, account management, product (e.g., game) configuration and customer profiling services. The OLTP tools may be implemented in any combination of hardware and/or software including simultaneous execution on multiple transaction processing servers or hosts. The OLTP system 206 may be configured to process wagers, e.g., lottery ticket purchases or game entries in a large variety of games. In particular, the game transactions may include purchases for entries in future draw games, or “online” or “instant” games where the outcome of the game is also determined as part of the initial transaction, as well as other variations and combinations of game logic.

The OLTP system 206 may include a basic OLTP Platform 210 which the games are based around. Although the implementations of the OLTP Platform may vary among different shared hosts, each OLTP platform generally includes a set of specifications to which each game must conform. For instance, the games may be programmed for a specific operating system (OS) environment or programmed using a specific language (e.g., C, C++, JAVA, etc.). This provides a standard to which developers may need to comply with when developing new games.

The OLTP platform 210 may be in communication with a Game Services component 215. The Game Services component 215 may be configured to provide a uniform set of services which may be accessed by games 207, 208 and 209 located in the OLTP system. For example, a basic service may include wager processing. Other services may also include a validation service to verify winning wagers, a randomization service to provide a uniform procedure of generating random numbers requested by a game, a player registration service to identify users and manage user profiles, and a reporting service to report the results of a gaming transaction to the user or the operator. In addition to generic services that are accessible to each game, the OLTP platform 210 may include specific services tailored to the requirements of a particular game.

An additional example Game Service component 209 is a Play Slip Analysis component 216. The Play Slip Analysis component 216 may be implemented in any combination of hardware and/or software. The Play Slip Analysis component 216 may be configured to interpret the player selections and other game parameters against game configuration data and/or rules stored at the Shared Host 201. For example, a particular game may be implemented differently, with varying rules across jurisdictions. Each jurisdiction's operator may customize the game and this may require the player selections to be analyzed to determine whether the selections are valid, and how the selections interact to execute a particular game selected. If the player selections are valid against the operator's predefined rules and the player selections are valid for the game selected, the Play Slip Analysis component 216 may initialize other game service components to fulfill the gaming transaction in accordance with the player selections. It will be appreciated the entire Play Slip analysis capability may be alternatively provided at the terminals, e.g., with software code downloaded when new types of games are activated.

Another game service that may be provided by the Game Services component 215 is a storage service for maintaining records of games. Records may be stored in a database of the shared host. Operators may opt to keep a record of winning numbers, names and contact information of winning users, and other game information. Records of outstanding tickets and unredeemed prizes may also be recorded. Storage may also be provided for games that have not yet ended. For example, users may place wagers on a game which has a drawing time in the near future. The storage service will keep a record of the user's identities (e.g., through player registration, self-provided contact information, credit card information, etc.). Other game parameters, such as user-selected numbers and wager amounts may also be stored. If a game requires multiple user interactions over time (e.g., video poker), the storage service may dynamically update stored records in accordance with changes made by such interactions. In some embodiments it may be desirable to segregate game data from customer data. For example, contact information, purchase records, win records and other customer data may be stored separately in another database on the shared host

The game services may in turn interface with a variety of game transaction logic components, e.g., software codes stored on the Shared Host 201. These game transaction logic components include game-specific components associated with each game in addition to generic logic components, each of which may be configured to perform transactions for particular games. The logic components may be codified in the form of executable math and business rules which may be executed by the game services. Results of the execution are then provided to games that request a service associated with these rules.

Also provided in the Shared Host 201 may be a Content Server 211, which delivers channel content between the shared host and the operators. The Content Server 211 may include a Channel Config Engine 212, which may be constructed to enable the operators of the shared host to create configuration data relating to individual game operators. The configuration data may, for example, include game operator-requested game customizations, such as a format in which in-game graphics are displayed to player customer users (e.g., specific fonts, graphics menus, operator-specific logos and messages, and other graphics elements). The Content Server 211 may also include a Channel Content Engine 213, which may include a database of channel content corresponding to the configuration data. Accordingly, the channel content may include logos, font libraries, billing records, usage records (e.g., the number of times each game was requested by a user or an amount of bandwidth used by a game operator during current and past billing cycles).

A Hosted Services engine 214 may provide all of the retailer, player and back office applications required by each of the jurisdictions.

The Shared Host 201 may include a communications service engine 204, which communicates with the lottery jurisdiction or other game operators 220 to deliver transaction requests to the Shared Host 201. Delivery may occur via any wired or wireless communications network such as a LAN, a WAN, a telephone network, the Internet, etc. Alternatively, e.g., in a single operator model, the host may communicate directly with the same terminals.

A Service Interface 205 may provide direct access to games located in the OLTP 206 by communicating with a Video Host 231 or a Casino Server 241. Games and game services may be delivered from the video host and the casino server to a channel device such as a Video Lottery Terminal (VLT) 232 or a Slot Machine 242. Additionally, the Service Interface 205 may be configured to deliver channel content directly to the channel devices.

An Acquirer Service Engine 203 may be provided as part of the Shared Host 201. The Acquirer Service Engine may facilitate communications between the Service Interface 205 and the Communications (Comm) Service Engine 204. The Acquirer Service Engine 203 may direct the transactions to an appropriate component of the shared host for processing. For example, a gaming transaction may be directed to the OLTP 206 while a back office transaction may be directed to the Hosted Services engine 214. Thus, local transaction processing at the jurisdictions may be avoided.

In the example system 200 described above, a player may be issued a play slip at any of the jurisdictions in connection with a game to be played. The play slips may be manufactured according to the specifications of a game operator in each jurisdiction. For example, a lottery operator may choose to provide access to existing games which require particular play slips (i.e., slips with predetermined configurations and layouts). When a lottery operator wants to provide access to a new game (e.g., a game written specifically for the lottery operator) or to a preexisting game customized to the operator's specifications, a new type of slip may be created and made available to the player.

Processing of the play slip may be performed in a manner similar to that of the System 100 shown in FIG. 1. A slip processing device may be a game terminal at the Lottery Jurisdiction 220, the VLT 232 or the Slot Machine 242. The slip processing device may be configured to read the encoded data from the play slip, locate the selection area(s), read the player selections contained in the selection area(s) and generate a game transaction request to the shared host 201. Alternatively, the same transaction request may be processed locally, rather than at a shared host. Examples of slip processing devices at the Lottery Jurisdiction 220 may include an Agent Terminal 221 manually operated by a lottery agent, and a self-service kiosk or Lotto Vending Machine 222, which may alternatively be a self-service, quick dispensing ITVM. Another slip processing device may be a player's personal computer (PC) 223 or a mobile device such as a mobile phone or PDA. The self-serve Lotto Vending Machine (or ITVM) 222, the VLT 232 and the Slot Machine 242 may also be respectively equipped with Slip Readers (not shown), 233 and 243 to enable slip processing capabilities, or slip reading capability may be provided with or exist in a device such as a camera on a phone or PC. Each slip processing device may be configured to capture a digital image of a play slip and locate player selections based on encoded data on the slip.

Depending on the type of game being played, game transaction requests may include the player selections as parameters. For example, if the game is an “instant-win” game or a game where the result is selection independent, then the player selections may not be included. However, where the player selections affect the outcome of the game, the player selections may be transmitted together with the game transaction request, either as part of the same communications packet or as a separate packet. Game parameters may be extracted from the play slips using the slip processing devices and transmitted to the shared host 201, via an operator server (e.g., a lottery operator server, the Video Host 231 or the Casino Server 241), for further processing. Game results may then be generated at the shared host 201 and transmitted to the game operator via the Communications Service Engine 204 or the Service interface 205.

Some example play slips will now be described. The example play slips may be utilized in conjunction with any of the systems described above and generally include a selection area in which a player indicates his play selections and an encoded data portion, which may but need not be visible to the player. In the example play slips, the encoded data will be described with reference to a bar code. More specifically, the bar code may be a two-dimensional bar code. It will be appreciated that other encoding arrangements besides bar codes may also be used. For example, in other embodiments, the encoded data may be printed on a one or three-dimensional bar code. The encoded data may also be printed as a sequence of characters, which may be in a human or machine-readable language that is read through an optical character recognition method. Alternatively, the encoded data need not be limited to printed arrangements. For example, the encoded data may be encoded on an RFID tag and wirelessly transmitted to a slip processing device. The encoded data may also be encoded on an integrated circuit such as a smart card, or as a magnetic strip which can be read by swiping through a credit card style reader.

As will be discussed, the encoded data may include location information which describes a location of the selection area relative to the rest of the slip. The encoded data may also contain other information relevant to game play. For example, the encoded data may contain a game identifier corresponding to the game being played. The encoded data may also include a game logo or a recorded message, which, after being read by the terminal, may be displayed to the player at an output device such as a video display or a loudspeaker. It will be appreciated that the information need not be encoded directly; in some instances, it may be desirable (e.g., for security or storage capacity reasons) to store the actual data on a separate device such as a remote server. In these instances, the encoded data may contain a reference to the actual data. For example, the encoded data may reference a game logo, which the terminal may locate using the encoded information from the play slip, access, and present to the player either by printing or video display.

In addition to stored data, the encoded data may include instructions for decoding the player selections. For example, the instructions may specify the manner in which the player selections should be indicated (e.g., bubbled-in, crossed-out, hand-written, punched-out, etc.). The instructions may also include information relating to the validity of the player selections. For example, if the game operator has specified a rule where the player can choose a maximum of three entries, this rule may be represented by the instructions. Play slips with more than three entries then can be flagged as invalid and trigger an exception condition. Other validity instructions such as valid selection combinations and minimum quantity of selections are also possible.

When new games are to be provided in the system, rather than reprogramming all the terminals, new play slips that are self-describing may be provided. Alternatively, additional information and decoding programs may be downloaded from the host to the various terminals as part of activating a new game. In a system with multiple jurisdictions or game operators, different sets of terminals may have different sets of active games. A game operator may make a request to activate a new game, e.g., because the game is successful for another operator. Responsive to this request, a shared host may download the game to the plurality of game terminals, including software configured to at least decode the player selections slips for that game. The decoding program may include information on how to interpret player selections on the play slips, a decoding program for interpreting the slips, information on the relative positions of various information on the play slips, and information indicating how to determine whether entries on the play slips are valid. Alternatively, if the selection slips are completely self-describing, the game software may not need to download any new decoding software. Rather, it may be sufficient to download software that allows certain terminals to generate selection slips for the new game. Or, in another alternative, the slips may be printed centrally and distributed to locations where they can be obtained by players.

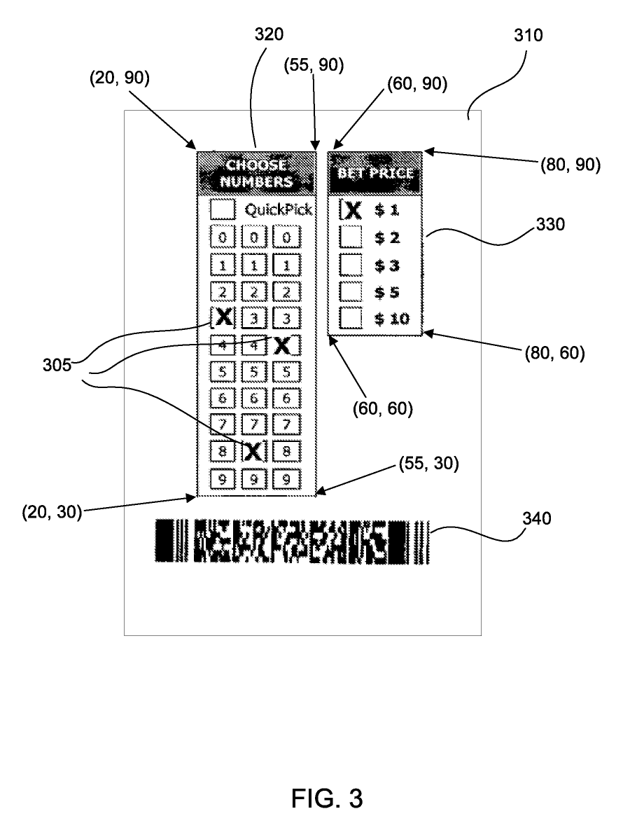

FIG. 3 illustrates an example of a play slip 310, according to an example embodiment of the present invention. The example play slip 310 may include selection areas 320 and 330 and encoded data 340, e.g. a bar code or other machine-readable data. The selection areas 320 and 330 are shown as rectangles. However, in other embodiments, the selection areas may have other geometric shapes, such as circles, ellipses, etc. As shown in FIG. 3, the selection area 320 corresponds to a number selection grid in which a player has indicated a selection of the numbers 3, 8 and 4 using selections marks 305. The selection area 330 corresponds to a wager amount.

The bar code 340 may indicate the locations of the selection areas 320 and 330 using a coordinate system. Coordinates for one or more points of each selection area may be encoded into the bar code 340 to indicate the boundaries of the selection areas. Each coordinate may be referenced to an origin point which has a predetermined coordinate value (e.g., (0, 0)). In the example play slip shown, the origin is the lower left-hand corner of the play slip. It will be appreciated that the origin point may be at any predetermined location, e.g., any corner, or at some offset from a corner or side. Alternatively, the origin point may be a reference point with a recognizable mark, e.g., a colored registration mark. In some cases, the reference point may be located without any information. For example, the processing device may be programmed to use the lower left-hand corner of the slip as a default origin point. If a different origin point is desired, the encoded data may specify another location and/or a different method of locating the origin point (e.g., by describing the recognizable mark). In this manner, the coordinates of the selection area 320, starting from the lower left-hand corner and moving clockwise may be represented as (20, 30), (20, 90), (55, 90), and (55, 30). Similarly, the coordinates of the selection area 330, starting from the lower left-hand corner and moving clockwise may be represented as (60, 60), (60, 90), (80, 90), and (80, 60). The coordinate values may correspond to either a fixed unit of measurement (e.g., millimeters or pixels), or a relative unit of measurement. For example, the coordinate values may specify a percentage of the total length or width of the entire play slip. The relative coordinates may enable the slip processing device to locate the selection area without having to calculate the actual distance of each coordinate.

The size of the set of coordinates encoded may vary depending on the shape of the selection area. If the selection area is rectangular for instance, the selection area may be specified using three sets of coordinate points.

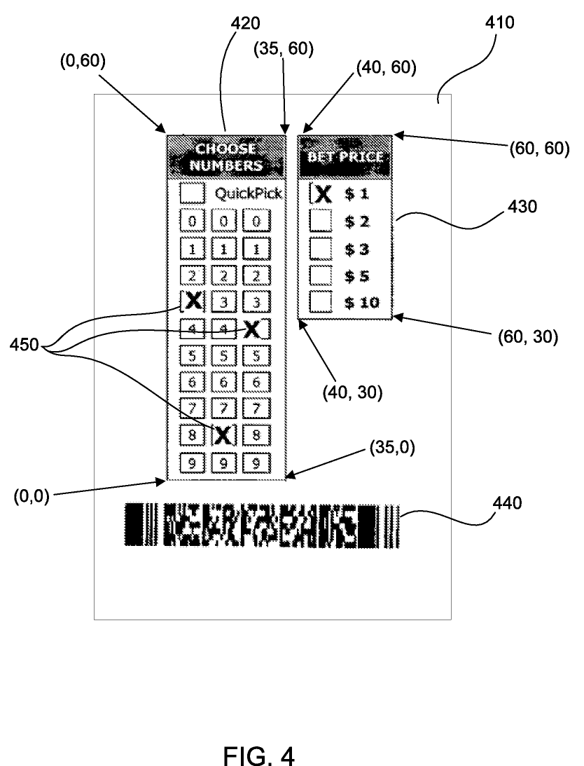

FIG. 4 illustrates an example play slip 410, according to an example embodiment of the present invention. The example play slip 410 may be similar in appearance to the play slip 310 and may include a selection area 420 for choosing numbers and a selection area 430 for choosing a wager amount; the choice in each case may be indicated by example selection marks 450. However, a bar code 440 of the play slip 410 may contain information that specifies the coordinates of the selections areas using relative coordinates. That is, the coordinates may be relative to each other. In the example play slip shown, the coordinates are relative to a single starting coordinate that is the lower left-hand corner of the selection area 420. Other starting points may also be possible, e.g., starting at a point outside of the selection area. Although the coordinates of both selection areas 420 and 430 are indicated relative to the starting point, alternatively each selection area may have its own respective starting coordinate. As shown in FIG. 4, the coordinates of the selection area 420, starting from the lower left-hand corner and moving clockwise may be represented as (20, 30), (0, 60), (35, 60), and (35, 0). Similarly, the coordinates of the selection area 430, starting from the lower left-hand corner and moving clockwise may be represented as (40, 30), (40, 60), (60, 60), and (60, 30). The coordinate (20, 30) indicates that the lower left-hand corner of the selection area 420 may be 20 units to the right and 30 units above the origin (i.e., the lower left-hand corner of the play slip). Once the starting point has been established, the remaining coordinates may be indicated relative to the starting point. Thus, the upper left-hand corner of the selection area 420 may be indicated as (0, 60) because this point is 60 units above the starting point. In this manner, each coordinate is specified relative to the starting point.

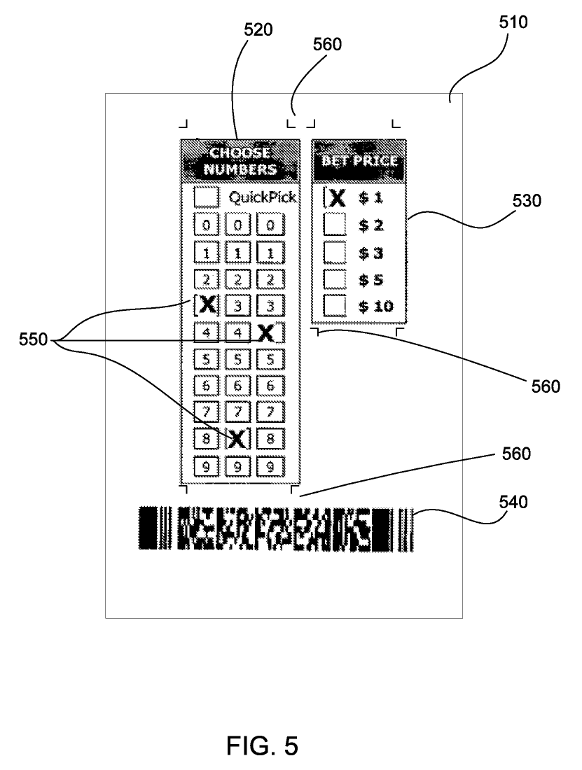

FIG. 5 illustrates another example play slip 510, according to an example embodiment of the present invention. The play slip 510 may include selection areas 520 and 530 in which selection marks 550 are located. The play slip 510 may also include a bar code 540 and one or more delimiting marks 560 to indicate the location of the selection areas 520 and 530. The number of delimiting marks may vary. For example, a simple play slip having a single selection area of known dimensions may be specified using one delimiting mark. As shown in FIG. 5, each corner of the selection areas may be indicated with a delimiting mark 560 that is located a predetermined distance away from the corners. The slip processing device may recognize the delimiting marks because of data encoded in the bar code 540. For example, the bar code 540 may specify what type of delimiting mark is used, the size of the delimiting mark, the distance between the delimiting mark and the point the delimiting mark refers to, the total number of delimiting marks on the slip, etc.

In some other example play slips, delimiting marks may be used in conjunction with a coordinate system such as that described above with reference to FIG. 4. For example, a starting point may be indicated visually using a delimiting mark while the remaining points may be encoded as relative coordinates within a bar code. Other combinations of the approaches discussed herein for indicating the location of the selection area are also be possible.

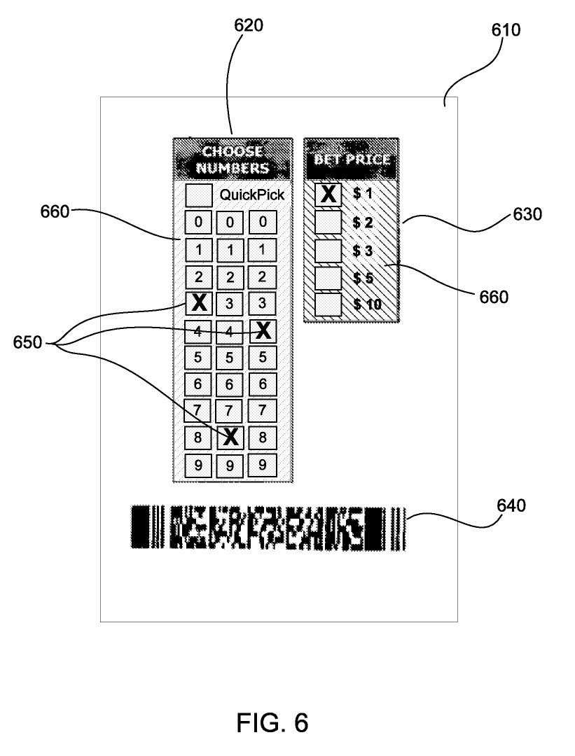

FIG. 6 illustrates another example play slip 610, according to an example embodiment of the present invention. The play slip 610 may include selection areas 620 and 630 in which selection marks 650 are located, in addition to a bar code 640. As shown in FIG. 6, each selection area may be printed with a background pattern 660. The background pattern may be any repeating pattern such as cross-hatching, regularly spaced or repeating grids. Because the background pattern 660 is only printed on the selection areas, the slip processing device can distinguish the selection area from other parts of the slip. To distinguish the background pattern 660 from other patterns or location methods (e.g., patterns used by another game), the background pattern may be indicated by the bar code 640 by either encoding the pattern directly or encoding a reference to a location where the pattern may be found. Different patterns, e.g., different types or colors of cross-hatching, may be used to identify different selection areas.

Other types of backgrounds may also be used to indicate the selection areas. For instance, the selection areas may be colored differently from the rest of the play slip. In addition, selection areas may be distinguished from each other by different patterns. Thus, in another example embodiment, the selection area 620 may use cross-hatching while the selection area 630 uses a solid red background. Accordingly, the bar code 640 may including information indicating to the system the location and type of printing on the ticket that should be ignored, e.g., the bar code may indicate the type and location of the cross-hatching (e.g., by encoding a sample cross-hatch pattern) in addition to the red background (e.g., by encoding an RGB color value corresponding to the red background).

In addition to describing backgrounds corresponding to selection areas, information contained in the bar code 640 may, in some embodiments, specify background areas or features to be ignored. Selective ignoring may occur where the play slip contains, for example, non-selection areas (game logos, graphics, play instructions, etc.) which are distinguished from selection areas by virtue of having a different background. Thus, in one example, the non-selection areas may have a solid background while the selection areas have a patterned background. In another example, the non-selection areas may have a red background while the selection areas have a blue background. Other background combinations may also be possible. Accordingly, the bar code 640 may enable location of the selection areas in one of several ways. First, information contained in the bar code 640 may explicitly describe the background of the selection areas. Second, the bar code 640 may omit information about the selection areas, but rather may describe the background of the non-selection areas. Finally, the bar code 640 may specify the backgrounds of both the selection areas and the non-selection areas.

In further example embodiments, other distinguishing features of the selection areas may be used to indicate their location. For example, if the slip processing device is capable of analyzing the digital image of the play slip, the selection areas may be located using edge detection. The slip processing device may scan the digital image to detect the edges of the selection areas by, for example, detecting contiguous pixels of the same color. In this example, the encoded data may indicate the color or thickness of the edge lines, or simply that edge detection should be used as the proper method for processing a particular play slip.

In another alternative example embodiment, slips or receipts with radio frequency identifiers (RFIDs), such as the tickets described in U.S. patent application Ser. No. 10/723,410, filed Nov. 24, 2003, titled RADIO FREQUENCY IDENTIFIERS IN GAME TICKETS, to Meehan et al., may be employed. Information encoded in an RFID tag may indicate where the customer-written information should be found on the slip or receipt and/or how the customer-written information on the slip or receipt should be interpreted.

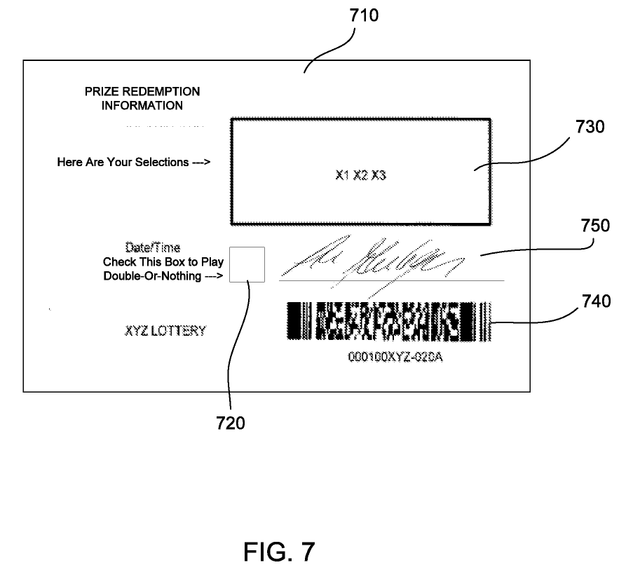

FIG. 7 illustrates an example receipt 710, according to an example embodiment of the present invention. The receipt 710 may be generated by the slip processing device in response to receiving and successfully processing the play slip. The receipt 710 may include a replay selection indication area 720, a game entry selection display 730, and a bar code 740. The game entry selection display 730 may reproduce the player selections which were previously indicated by the player, e.g., using the play slips described previously and read at a terminal, in a human-readable format. In some instances, reproduction may include arranging the player selections in an easy-to-read manner or providing a summary of the player selections. A complete, albeit reduced-size digital image may also be included. The bar code 740 may include information identifying the game played, the game operator, the player, and any other information useful for validating the receipt if later presented for prize redemption. For example, the bar code 740 may include a game identifier, a player identifier, an identifier corresponding to the play slip from which the receipt was generated, an operator identifier, etc. The receipt 710 may also include human-readable information such as game name, operator name, date/time, instructions for prize redemption and game logo (e.g., the game logo encoded within the play slip). The replay selection indication area 720 may provide the player with the option of using the receipt for a purpose other than prize redemption, such as a play slip for a new game, e.g., replaying the game using the previous selections (e.g., the selections indicated in the game entry selection display 730). For example, to replay the game, the player may check-off or mark the replay selection indication area 720 to indicate a desire to replay the game and then present the receipt at a game terminal for further processing. This allows a player to easily re-use their receipt in a time-saving fashion so they do not need to re-enter their “lucky” numbers each time they play. Alternatively, an option may be provided that allows the user to play the game again with a “double-or-nothing” feature where the prize obtained from the receipt is immediately converted, in whole or part, into a wager in a follow-on or bonus game. This may be indicated on the receipt by the player marking in a particular area of the slip prior to the slip being presented for redemption.

The bar code 740 may also encode information relating to a location of the replay selection indication area 720. The encoded information may be encoded using any of the procedures previously described with reference to play slips. Thus, the bar code 740 may specify the location of the replay selection indication area 720 using encoded coordinates, backgrounds, delimiting marks, etc. In this manner, a receipt processing device (e.g., a game terminal) may locate and read the information contained in the replay selection indication area 720 or in other areas where the players may indicate input information on the receipt. If it is determined from the replay selection indication area 720 that the player wishes to replay, a new instance of the game is executed using the previous selections, which may be read off of the selection indication area 720 or, if the player selections were stored, retrieved from a database. The player's prize from a winning receipt may be used to provide the necessary credit for entering the replay game when the player presents the receipt for redemption with the replay selection area appropriately marked.

It will be appreciated that the receipt 710 may enable a variety of replay options in addition to that described above. It was previously stated that the receipt 710 may function as a new play slip, eliminating a need for the player to fill out a new play slip. In further embodiments, the receipt 710 may enable the player to replay a game, but without using the previous selections as wager parameters. Instead of indicating a desire to use the same selections, the other selection indication areas may be provided that, for example, indicate that the player wishes to receive another play slip on which to mark new selections. To facilitate the obtaining of a new play slip, the receipt 710 may include encoded data (e.g., in the bar code 740) describing the new slip. Examples of encoded data describing a play slip include a compressed image of the play slip, a reference to a database containing an image of the play slip, and coordinates of selection and non-selection areas.

The encoded data on the receipt 710 may enable the original play slip to be reproduced fully (e.g., an exact replica of an unmarked play slip). Alternatively, it may sometimes be desirable to create a new slip which, while including the primary features of the original, differs in appearance and/or function. For example, the receipt 710 may be configured to generate an “express play slip” from a template included in the encoded data. The template may include the coordinates of pertinent selection and non-selection areas, a game identifier, a game logo, or other primary features. Secondary features such as game instructions and additional graphics may be omitted, since the player may either be familiar with how to play the game, or encoding the additional graphics would require more storage (e.g., a more complex bar code) at an added cost.

The receipt 710 may include an optional signature field 750 which the player may be required to sign before a game operator will accept the receipt for replay. The signature may be scanned and a signature image recorded for later verification, such as when a dispute arises as to whether the player actually consented to replaying the game, or when the player attempts to redeem the receipt for a prize. The signature image may be captured along with an image of the entire receipt 710 or separately. For example, the bar code 740 may include location information corresponding to the location of the signature field 750. A terminal processing the receipt 710 may read the bar code 740 to locate and capture a digital image of the signature field 750. Alternatively, the signature may be captured using an input device such as a signature pad rather than printed on the receipt. In an example embodiment, the captured signature image may be displayed to the player for visual verification prior to completion of the replay transaction. By confirming that the receipt was signed personally, the player is assured that his identity has been associated with the replay transaction

Some example methods according to example embodiments of the present invention will now be described. The example methods may be provided using any of the systems previously described. The methods will be described with reference to components of the systems 100 and 200. However, it will be appreciated that the example methods may be provided using different combinations of hardware and/or software.

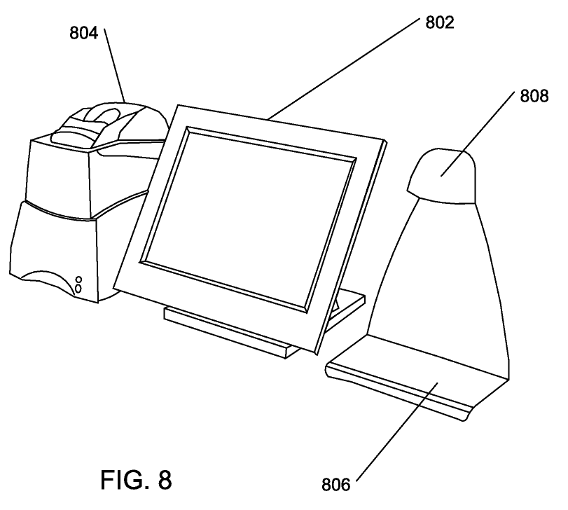

FIG. 8 illustrates an example agent operated lottery terminal, according to an example embodiment of the present invention. Although the terminal in FIG. 8 is illustrated as including separate components, it will be appreciated that the various components may also be provided in a single integrated device. Both the separate and integrated devices may be provided using modified versions of the Imagine™ lottery terminal available from GTECH Corporation of Providence, R.I. The example terminal may include a display 802, which may optionally be a touch screen display to allow convenient control by the agent operating the terminal. The example terminal may include a receipt printer 804 or other type of input or output device, e.g., a smart card reader or writer, a magnetic strip reader or writer, or other types of devices that allow printed or electronic receipts to be generated for a player in response to the purchase of a game play. The example terminal may also include an imaging location 806 where the player or the agent may place a play slip submitted for entry in a game or receipt presented for redemption. In imaging device 808, e.g., a CCD digital camera, may be positioned to image the play slip or the receipt in order to facilitate a transaction by the player, including for a play slip, a game entry purchase transaction, and for a receipt a redemption transaction.

It will be appreciated that the terminal may also include a processor (not shown) that operates under software, firmware, or hardware control to provide the capabilities previously described in the example system described above. In a “fat client” mode, all of the imaging, extraction, and reading capabilities that are required to process the play slip or receipt may be provided by a processor at the terminal. In a “thin client” mode a digital image of the play slip or receipt may be transmitted via network for further processing at a server or host.

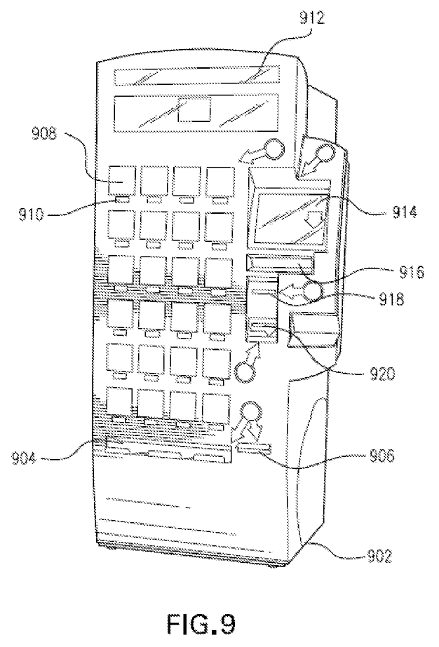

FIG. 9 illustrates an example player-operated kiosk, according to an example embodiment of the present invention. The terminal may be a modified version of the Gamepoint™ combined instant and online ticket vending self-service terminal available from GTECH Corporation of Providence, R.I. The terminal may be advantageously positioned where it can be accessed by players, e.g., in a retail store, or at a bar, train station or other convenient location, and may operate in a stand-alone mode or in a network configuration as described previously.

The example kiosk may have a cabinet 902 that contains and protects the various electronic and mechanical components. However, it will be appreciated that other configurations, e.g., where some components are separate peripherals attached to or in communication with the terminal may also be employed. An instant ticket dispensing area 904, allows player's to receive preprinted instant lottery tickets that are shown in various window displays 908 with prices or other messages shown in displays 910. An output slot 906 may be used to output receipts, tickets, or other items that are printed at the kiosk The kiosk may also have an advertising display 912.

The example kiosk may have a variety of types of input and reading devices. The example kiosk may have a video display screen, e.g., a touch screen, where players can make certain types of game selections or purchases. The example machine may also include a reader 916, having a cavity where a player may place a play slip or other media and have it scanned by a digital camera or other type of imaging device, e.g., which may be located on the top inside surface of the cavity. Another alternative form of input device may be reader 918 that may read bar-coded slips or other sorts of media. Bill acceptor 920 may be used to receive cash tendered by a player.

It will be appreciated that several different types of input devices have been illustrated in the example kiosk. As an alternative, machines providing similar services may be provided with fewer devices or with functionality of the various input devices moved from one input or reading component to another. For example, instead of displaying the available pre-printed instant lottery tickets behind the display windows 908, they could be displayed in video form on the screen 914. The bar-code based slip reader 918 could be deleted and bar codes could be read by extracting bar code images from the digital slip image obtained using the reader 916.

It will be appreciated that the machine illustrated in FIG. 9 may provide the terminal capabilities described previously in FIGS. 1 and 2. For example, a player may use a player completed play slip in the reader 916, which is used to provide a game display based on the play slip on screen 914, like a video game. Alternatively a receipt may be printed and provided at 902. If the machine has redemption capability, the receipt printed at 906 may later be presented by the player for the redemption of a game prize by having the receipt read in the reader 916.

While the reader has been described here with reference to an unattended kiosk, a similar capability may be provided with other sorts of devices, e.g., by provided a digital camera-based reader incorporated in a conventional Point of Sale (POS) terminal such as the terminals used for grocery store check-out, or by using the digital camera on a mobile telephone device, or a digital camera attached as a peripheral to a personal computer. For personal devices, such as the mobile telephone or personal computer, the player/user may communicate with the host via the Internet, e.g., imaging their play slip or receipt, whose contents may extracted and read and then transmitted via the Internet to a website provided by the game operator. Alternatively, the digital image may be transmitted to the website and processed centrally, although this requires additional network bandwidth. In jurisdictions where Internet wagering is permissible, this website may allow game entry, with payment made by credit card, or using a prepaid account. The player can also validate and redeem their own receipts and game tickets, provided those receipts have secure codes to insure they are authentic. Images of the tickets may be made and essential information extracted, eliminating the need for manual entry of information. This information may then be transmitted to a secure website and credit may be given to the player for winning tickets, e.g., by crediting a player account or providing credit to purchase more game plays. To reduce risk, prizes above a certain value may be diverted, so that the player is required to bring the physical ticket in to a service center for more complete authentication prior to redemption.

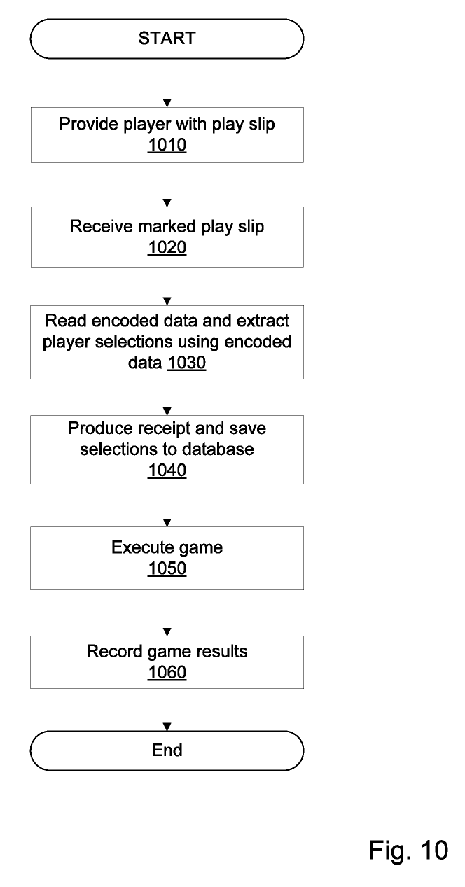

FIG. 10 illustrates an example method 10 for processing a play slip according to an example embodiment of the present invention. The example method may be provided, e.g., as software and/or hardware, in the system 100 or 200, described previously. In the example method, the player may be obtain or provided with a play slip. The obtaining or providing may occur at a game terminal (e.g., terminal 110), slot machine, or other slip processing device and may be performed in response to a request to play a game. The play slips may be pre-printed (e.g., scratch-off tickets or fill-in-blank play slips) or, alternatively, may be generated at the game terminal, e.g., using a printer or other slip generation device, in response to the request. For some games, pre-printed play slips may also be freely distributed and obtained, e.g., on hang tags or on writing desks in a retail location where game tickets are sold, as “take one” displays, in direct mail, or as an insert in a magazine or newspaper.

In 1020, a marked play slip may be received from the player, e.g., by a slip processing device. In some embodiments, the marked slip may be physically handed to an operator of the slip processing device such as a store clerk, who then can process the play slip with the slip processing device. Alternatively, if the slip processing device is self-service, the player may insert the slip into a receiving arrangement of the slip processing device, or alternatively hold it in the front of a digital camera mounted on the self-service system.

In 1030, the encoded data may be read, e.g., by a slip processing device, and selections from the play slip may be extracted. The reading of the encoded data may be performed by, e.g., scanning a bar code containing the encoded data. The encoded data may then be decoded to obtain location information which describes a location of a selection area relative to the rest of the play slip. A digital image of the play slip may then be captured, e.g., by a slip processing device, and the digital image may be subject to image processing. In particular, a location of the digital image corresponding to the location indicated by the location image may be scanned for marks associated with the player selections. The player selections may then be extracted and read using a process corresponding to the type mark (e.g., punch-out, hand-written, bubbled-in, scratch off, etc.). This may be done at a client device, such as the various sorts of game terminals described previously, or alternatively may be provided as a service by a central host.

In 1040, a receipt may be produced, e.g., by a slip processing device. The player may later redeem the receipt for a prize in the event that the player wins the game. The player selections may be saved, e.g., by a slip processing device to a database (e.g., a database located in the games services engine 130). The saved selections may be used for game play purposes (e.g., determining outcomes in games where the game outcome is dependent on player input) or for subsequent validation of winning receipts. The receipt may be printed, or a secure electronic record may be provided to the players e.g. stored on a mobile device or smart card.

In 1050, the game may occur, e.g., by being executed either locally or remotely, depending on the system. For example, the game may be provided locally at the game services engine 130 or remotely at the shared host 201.

In 1060, game results may be recorded, e.g., at the game services engine 130, and may also be transmitted for display to the player, e.g., at the game terminal. The results are preferably stored in a secure manner, e.g., encrypted, located on a secured or limited-access server, etc., to prevent tampering or unauthorized access.

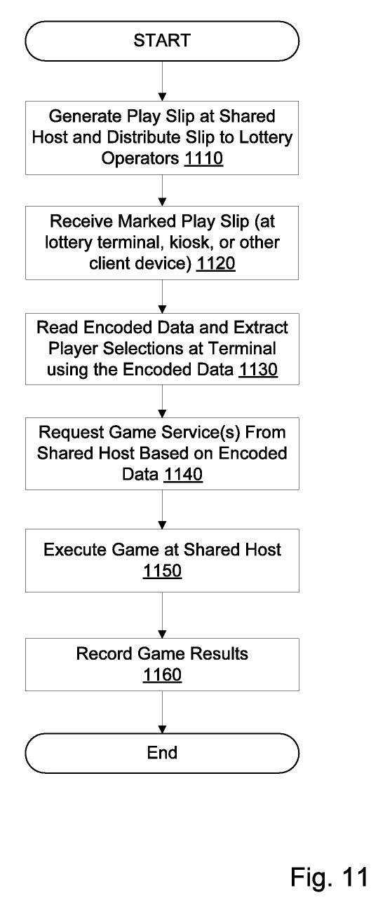

FIG. 11 illustrates another example method for processing a play slip according to an example embodiment of the present invention. The method may be implemented in the system 200, described previously, or in other hardware or software configurations. In 1110, a play slip may be generated, e.g., by the shared host, and may be distributed to lottery operators. Such an arrangement may be beneficial where games play is predetermined, and the slip merely indicates the player's desire to play a particular game, rather than having additional entry information. In such cases, the only requirements for game access may be that the lottery operator subscribe to the game, e.g., a game offered by the Shared Host 201. In that case, the play slips may be generated, e.g., by the Shared Host 201, and supplied to the lottery operator. Alternatively, lottery operators may choose to generate their own play slips, e.g., at game terminals, or have a third party manufacture the slips to operator specifications.

In 1120, the marked play slip may be received, e.g., one of the jurisdictions operating the lottery game by a slip processing device. The marked play slip may be physically handed to an operator of the slip processing device such as a store clerk. Alternatively, if the slip processing device is self-operated, the player may insert the play slip into a receiving arrangement of the slip processing device.

In 1130, the encoded data may be read from the play slip, e.g. by a slip processing device, and the player selections based on the encoded data may be extracted. This may be performed in a manner similar to that described above with reference to 1030 of the method illustrated above in FIG. 10.

In 1140, a game service is requested, e.g., by a slip processing terminal, from the Shared Host 201 based on the encoded data. For example, the request may include a game transaction request that includes the player selections as game parameters.

In 1150, the game may occur, e.g., by the Shared Host 201 executing the game corresponding to the game transaction request, and the game results may be delivered in a variety of ways, e.g., to the slip processing device for display to the player on an output device, by e-mail, by announcing the results in a broadcast or published media, on an Internet site, etc.

In 1160, the game results may be recorded, e.g., by the Shared Host 201, for subsequent validation or publication purposes. The game results may be recorded locally, e.g., at the Shared Host 201, or at a remote facility (e.g., a facility operated by a validation agency).

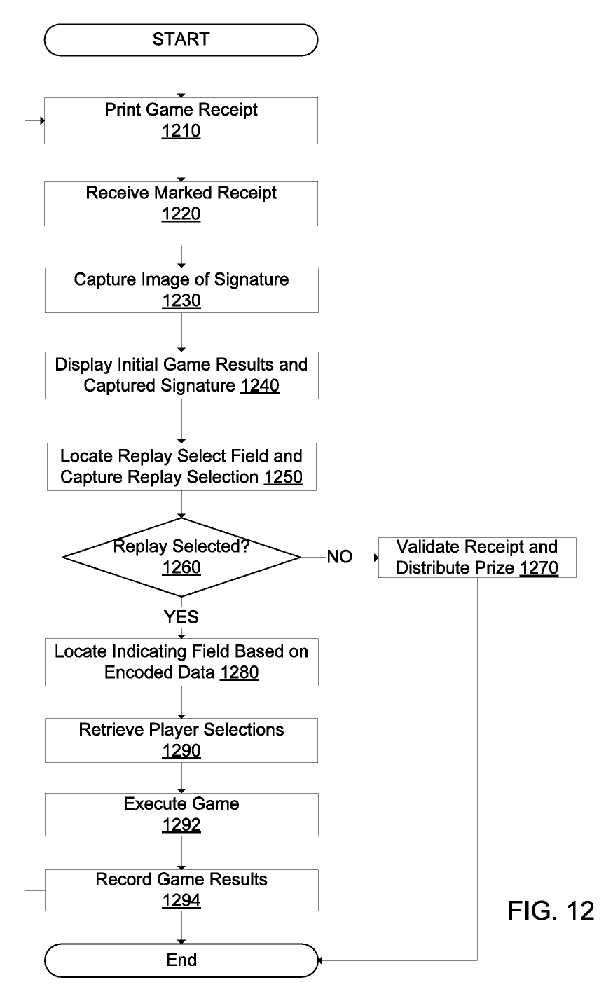

FIG. 12 illustrates an example method for processing a game receipt according to an example embodiment of the present invention. For example, the method may be provided in either of the systems 100 or 200, described previously. In 1210, a game receipt, such as the receipt 710, may be printed. This may occur after a player submits a play slip for processing. If the play slip contains a valid wager, the terminal may provide the receipt as a confirmation of the wager.

In 1220, a gamer operator may receive the receipt, which has been marked by the player to indicate a desire to replay or continue playing the game. For example, the game may operate in a manner similar to that of the Deal or No Deal™ television game show, in that the game includes multiple rounds of play during each of which the player makes one or more selections. In addition, any type of game may be replayed by marking the game slip to indicate consent to replaying. For example, after winning, the player may be present with the option of either cashing out with the money won from the previous game or pooling his winnings towards another instance of the game (e.g., a “double or nothing” type wager). The receipt may be printed at any of various locations, including at a terminal processing the receipt, a pickup window, and the player's own home. Depending on the encoding format of the receipt, virtually any printing device may be used to perform the printing. For example, optical formats such as bar codes may be printed using a standard inkjet or laser printer. The printer may be accessed using the player's own computing device, which obtains the receipt electronically from the game operator (e.g., via email, a secure Web connection, FTP, fax, etc.).

In 1230, an image of the signature may be captured by the terminal, which may, for example, utilize a digital imager. To capture the signature, a signature field on the receipt may be located by the terminal based on encoded data which, for example, may include location information similar to those described above with reference to example play slips. Thus, the height, location, size, and other attributes of the signature field may be discerned by the slip processing device based on the encoded data. In this manner, the signature may be read from the signature field. The signature may be captured alone (e.g., only an image of the signature field is taken) or together with the entire receipt. If the signature is captured together with the receipt, the signature image may be segregated from the receipt image by cropping away portions not corresponding to the signature field. After capturing, the signature may be stored for later verification (e.g., locally at the terminal or on a remote database).

In 1240, the initial game results from the previously played game are displayed to the player. This may be performed using any standard display device in communication with the terminal. The captured signature may also be displayed to the user to confirm that the receipt has been associated with that particular player. Viewing the signature may provide the player with assurance that the receipt (and any winnings associated therewith) will be protected against misappropriation.

In 1250, the replay selection may be captured by locating and reading the replay select field. The capturing may be performed automatically by, for example, using a digital imager or other mark sensing device. Alternatively, the replay selection may be performed manually by a human operator who may visually inspect the receipt and complete a gaming transaction request in response to viewing the replay selection.

In 1260, it may be determined whether the player has selected to replay the game. This may be performed by using the digital imager or other mark sensing device to confirm the presence of a valid mark in the replay select field. The determination may also be performed manually by, for example, visually inspecting for unambiguous marks (e.g., a checked box or a fully bubbled-in circle).

In 1270, replay has not been selected and the receipt may be validated to confirm that the receipt is a valid winning receipt. Validation may be performed at a remote location such as a validation agency in communication with the terminal. Depending on the game and the amount of money at stake, validation may be performed instantaneously by performing image processing on the receipt or may be performed at a subsequent time by subjecting the receipt to more rigorous validation methods. Once the receipt has been validated, prize winnings may be distributed to the player.

In 1280, replay has been selected and an indicating field may be located based on the encoded data of the receipt. The encoded data corresponding to the indicating field may be located separately from the encoded data corresponding to the signature field. Generally, the indicating field may be indicative of player selections. If, for example the game is a Deal or No Deal™ type game, the player may have the option of making new selections. Accordingly, the indicating field may function in a manner similar to that of the selection fields previously described with reference to example play slips. That is, the receipt may include encoded data with location information to aid the terminal in locating and reading new selections contained within the indicating field. However, if the game is of a type where the player does not make new selections and only replays previous selections, the indicating field may simply be a non-markable area on which is printed, in a human-readable format, the previous selections.

In 1290, the player selections may be retrieved by, for example, reading the indicating area. In some examples, the indicating area may include a reference to a location where the player selections are stored and from which the terminal may retrieve the selections. In some other examples, the terminal may be configured to request a database search for the player selections.

In 1292, the game may be replayed or continued, e.g., executing the game once again in a game system. Prior to execution, consent to replay or continue play may be determined. In some alternative examples, the receiving of the receipt may be sufficient to indicate the player's permission or desire to replay the game, in which case 1230 to 1250 may not be necessary. In other alternatives, the indicating area (or any other area) may be marked to indicate consent. Thus, the terminal may examine the indicating area in addition or as an alternative to capturing and comparing the signature.

In 1294, the game results may be recorded (e.g., at the Shared Host 201, the local Game Services engine 130, or a remote server). The results may subsequently be accessed for validation or publication purposes. If the game is continuing, the example method may return to 1210, where a new receipt is printed. In another example, the receipt may be reused. For example, a Deal or No Deal™ type game may be played by systematically selecting choices on the same receipt, where each selection is thereby eliminated from future selecting. As an illustration, if a player could select 3 boxes out of 20 and won $10, the player may be presented with the option of risking the $10 and picking 2 more boxes.

It will be appreciated that all of the disclosed methods, games, and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods, games, and procedures.

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense.

1. A system for processing a selection slip for a game, the system comprising:
a gaming terminal, the gaming terminal including
an imaging device configured to generate a digital image of a player selection slip,
a slip processing engine configured to extract player selection data from the digital image of the selection slip, the extraction of player selection data based on information read from the slip indicating how player-written marks found on the slip should be interpreted, and
a communication engine configured to communicate requests for game execution to a game services engine, the requests based at least in part on player selection data extracted by the slip processing engine
a receipt generator configured to generate a game receipt based at least in part on the player selection data;
the game services engine configured to execute instances of the game, the game services engine including
a game entry engine configured to receive and process information indicating player game entries,
an outcome engine configured to determine an outcome of a game, and
a validation engine configured to validate redemption requests for the game receipt based at least in part on the player game entries and outcome of the game associated with the game receipt.

2. The system of claim 1, wherein the gaming terminal is a dedicated agent-operated lottery terminal.

3. The system of claim 1, wherein the gaming terminal is a dedicated player-operated lottery terminal.

4. The system of claim 1, wherein the information indicating how player-written marks should be interpreted includes location information indicative of the location of a selection area on the form relative to the remainder of the form.

5. A system for processing a manual input entry form, the system comprising:
an imaging device configured to generate a digital image of the form; and
a reading device configured to read encoded data from the form, the encoded data including location information indicative of the location of a selection area on the form relative to a remainder of the form.

6. The system of claim 5, wherein the encoded data includes instructions indicating how selection marks contained within the selection area should be interpreted.

7. The system of claim 6, wherein the encoded data is contained in at least one of a bar code, an RFID tag, a printed character sequence, an integrated circuit, or a magnetic strip.

8. The system of claim 6, further comprising:
a slip processing engine configured to extract the selection area from the digital image of the form using the location information.

9. The system of claim 8, further comprising:
a selection area analysis engine configured to interpret selection marks written by a user in the selection area.

10. The system of claim 9, further comprising:
a game play engine configured to enter the user in a wagering game, the user's entry in the wagering game based at least in part on the interpretation of the selection marks made by the selection area analysis engine.

10. The system of claim 5, wherein the imaging device and the reading device are part of a self-service lottery terminal.

11. The system of claim 5, wherein the imaging device and the reading device are part of an agent-operated lottery terminal.

12. The system of claim 5, wherein the imaging device and the reading device are part of a mobile device.

13. The system of claim 5, wherein the imaging device and the reading device are part of a point-of-sale terminal.

14. The system of claim 5, further comprising:
an entry form generation device configured to generate the form.

15. The system of claim 5, wherein the reading device is configured to receive the digital image from the imaging device and to extract the encoded data from the digital image.

16. A system for providing services to lottery operators, comprising:
a shared lottery host accessible to a plurality of game terminals; and
a game archive accessible to the shared lottery host storing software code configured to operate a plurality of wagering games at the game terminals, the games selectively activatable by the operator of the plurality of game terminals, at least one of the games configured to receive play selections for game play using player selection slips that include stored play slip decoding information,
the shared lottery host configured to download, responsive to a request to activate the at least one of the games by the operator of the plurality of game terminals, software configured to at least one of generate or decode the player selection slips for the game.

17. The system of claim 16 wherein the software includes a program configured to generate player selection slips that include the instructions indicating how the player selections slips should be interpreted.

18. The system of claim 16, wherein the software is a decoding program, and wherein the plurality of game terminals are configured to execute the decoding program to interpret the player selection slips for the game.

19. The system of claim 17, wherein the decoding is based at least in part on instructions provided on the player selection slip that indicate the location of a selection area on the player selection slip relative to a remainder of a player selection slip.

20. The system of claim 18, wherein the decoding program includes instructions on how to determine whether player selections located in the selection area are valid.

21. The system of claim 18, wherein the decoding programs include instructions to locate the selection area based on one of coordinate information, delimiting marks, edge detection and background image.

22. The system of claim 18, wherein at least one of the terminals includes a digital imager configured to capture an image of the slip and perform an image extraction procedure to locate the selection area in accordance with the instructions of the at least one decoding program.

23. The system of claim 16, wherein the stored play slip decoding information is contained in one of a bar code, an RFID tag, a printed character sequence, an integrated circuit and a magnetic strip.

24. The system of claim 16, wherein at least one of the terminals is configured to produce a receipt including human readable versions of the player selections and transmit the player selections for storage at the shared host.

25. The system of claim 16, wherein at least one of the terminals is configured to apply the player selections towards a new instance of a game after receiving the receipt from a player.

26. The system of claim 16, wherein at least one of the terminals is a retail point-of-sale terminal.

27. The system of claim 16, wherein at least one of the terminals is configured to generate the slips.

28. The system of claim 16, wherein the shared lottery host is configured to generate the slips.

29. A method for processing a manual input entry form, comprising:
reading encoded machine-readable data from the form with an input device at a terminal;
decoding the encoded data to obtain location information indicative of the location of a user selection area on the form relative to a remainder of the form;
using the location information to determine with the terminal the user selections contained within the indicated selection area.

30. The method of claim 29, wherein the user selections are indicated by writings made by the user in the selection area with a writing instrument.

31. The method of claim 30, further comprising:
generating a receipt containing human readable versions of the user selections.

32. The method of claim 31, further comprising:
storing the user selections in at least one of a remote database and an encoded data portion of the receipt.

33. The method of claim 31, further comprising:
after receiving the receipt at a terminal, generating a new instance of an operation initiated by the decoding of the entry form using the user selections contained on the receipt.

34. The method of claim 31, further comprising:
performing the new instance only after confirming the user's consent to the new instance by reading a consent indicating area of the receipt.

35. The method of claim 34, further comprising:
locating the consent indicating area by extracting location information from data encoded on the receipt.

36. The method of claim 31, further comprising:
reading the receipt to obtain encoded data corresponding to a second entry form;
generating the second form; and
applying user selections located on the second form towards another instance of an operation initiated by the decoding of the first form.

37. The method of claim 29, wherein the form is a wagering slip for a lottery game.

38. The method of claim 29, wherein the form is a wagering slip for a sports betting game.

39. The method of 29, wherein the encoded data further indicates at least one of patterns or colors on the form that should be ignored when reading the user selections.

40. The method of claim 29, wherein the location information is indicated with reference to a known reference point on the form.

41. The method of claim 29, wherein the encoded information provides an indication of reference symbols on the form which can be located and which, once located provide the known reference point on the form.

42. The method of claim 29, further comprising:
capturing a digital image of the form, wherein the reading of the form is performed using the digital image.

43. The method of claim 42, wherein the capturing of the digital image is performed by a terminal including a digital imager.

44. The method of claim 43, wherein the terminal is a retail point-of-sale terminal.

45. An article of manufacture, comprising a computer readable medium having a computer-readable program code embodied therein, said computer readable program code configured to be executed to carry out the method of claim 29.

46. A manual input entry form, comprising:
a selection area configured to allow a user to mark a selection;
a machine-readable encoded data, the data including location information indicative of a location of the selection area relative to a remainder of the form.

47. The entry form of 46, wherein the selection area is configured to allow the user to mark the selection by writing in the selection area with a writing instrument.

48. The entry form of claim 46, wherein the encoded data is located on one of a bar code, an RFID tag, a printed character sequence, an integrated circuit and a magnetic strip.

49. The entry form of claim 46, wherein the location information includes coordinate information.

50. The entry form of claim 46, wherein the location information includes instructions configured to locate a distinguishing feature of the selection area.

51. The entry form of claim 50, wherein the distinguishing feature is a delimiting mark.

52. The entry form of claim 50, wherein the distinguishing feature is an edge of the selection area.

53. The entry form of claim 50, wherein the distinguishing feature is a background image of the selection area.

54. The entry form of claim 46, wherein the encoded data includes instructions configured to control interpretation of the selection.

55. The entry form of claim 46, wherein the encoded data includes information configured to be used to determine whether the selection is a valid selection.

56. The entry form of claim 46 wherein the encoded data identifies a service provider capable of processing the form.

57. The entry form of claim 46, wherein the form is a wagering slip for a lottery game.

58. The entry form of claim 46, wherein the form is a wagering slip for a sports betting game.

59. The entry form of claim 46, wherein the encoded data includes at least one of a game identifier, a game logo, a reference to a game identifier, and a reference to a game logo.
